(19) United States
(12) Patent Application Publication
(10) Pub. No.: US 2004/0126045 A1
(43) Pub. Date: Jul. 1, 2004

(54) Textured rolling element bearing

(75) Inventors: Thomas Victor Falone, Michelton, NJ (US); Chandrasekhar Nataraj, Radnor, PA (US); Carmen N. DiMario, West Chester, PA (US); Robert A. Vito, Berwyn, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: American Ball Bearing

(21) Appl. No.: 10/329,850

(22) Filed: Dec. 26, 2002

(51) Int. Cl. F16C 33/62; F16C 33/32; F16C 33/58

(52) U.S. Cl. 384/492; 384/569

(57) ABSTRACT

A textured rolling element bearing and method for determining a texture that improves bearing performance parameters. The bearing has a first bearing element with a first surface and a second bearing element with a second surface. The first surface is rollable with respect to the second surface and has a first predetermined macro-texture. The method steps include selecting a bearing performance parameter and establishing a corresponding bearing performance goal, prospectively defining a topography for the first surface and formulating and iteratively solving a contact model representing an elastic deformation of the first surface relative to the second surface based on a separation distance “h” between the first and second surfaces, a fluid model representing a pressure “p” of the lubricant between the first surface and the second surface; and a viscosity model representing a viscosity “μ” of the lubricant based on the pressure of a lubricant between the two surfaces.

### BACKGROUND OF THE INVENTION

The present invention relates generally to rolling element bearings. More specifically, the present invention relates to rolling element bearings having a textured surface and further relates to a method for determining the topology of the textured surface.

Conventional rolling element bearings consist of balls or rollers that have been manufactured to be extremely smooth. In conventional bearings, the random roughness of the “smooth” surfaces is of the order of 10⁻⁸ m, which is about 100 atomic diameters. The contact of such a conventional rolling element surface with a raceway under the combined action of applied loads and kinematic constraints produces a combination of rolling, sliding and spinning motions. These motions serve to draw lubricant into the contact. The pressures and temperatures vary throughout the contact region, and have a significant effect on lubricant properties. A thin film is formed that separates the contacting bodies to an extent that depends on both the micro-geometry and macro-geometry of the bodies, the properties of the lubricant and the dynamics of the system. Depending on the thickness of the lubricant film relative to the roughness of the rolling contact surfaces, the direction of the roughness pattern can affect the film-building capability of the lubricant.

Rolling contact surfaces having superimposed on conventional roughness patterns a predetermined macro-texture with the topology disclosed and claimed herein can improve lubricant flow to the contact area of the bearing surfaces and thereby improve the performance and life of rolling element bearings.

### BRIEF SUMMARY OF THE INVENTION

One aspect of the present invention is a textured rolling element bearing comprising a first element and a second element. The first bearing element has a first surface with a first predetermined macro-texture. The second bearing element has a second surface. A lubricant is between the first and second surfaces. The first surface is rollable with respect to the second surface.

Another aspect of the present invention is a method for determining for a first surface of a rolling element bearing a topography for improving a bearing performance parameter. The first surface is rollable relative to a second surface of the bearing. A lubricant is between the first surface and the second surface. The method comprising the steps of (a) selecting a bearing performance parameter and establishing a corresponding bearing performance goal; (b) prospectively defining a topography for the first surface of the bearing; (c) formulating a contact model representing an elastic deformation of the first surface relative to the second surface based on a separation distance “h” between the first and second surfaces; (d) formulating a fluid model representing a pressure “p” of the lubricant between the first surface and the second surface; (e) formulating a viscosity model representing a viscosity “μ” of the lubricant based on the pressure of the lubricant; (f) determining simultaneously the separation distance, the pressure, and the viscosity by analytical approximation and numerical simulation of the contact model, the fluid model, and the viscosity model; (g) determining a value for the bearing performance parameter based on the separation distance, the pressure, and the viscosity determined in step (f); (h) determining a value for the bearing performance parameter based on the separation distance, the pressure, and the viscosity determined in step (f) and the bearing stress determined in step (g); (i) ascertaining whether the bearing performance goal has been satisfied; and (j) if the bearing performance goal has not been satisfied, then incrementally changing the topology and repeating steps (f), (g), and (h) until the bearing performance goal has been satisfied.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a cross-sectional view of a first preferred embodiment of a textured bearing in accordance with the present invention;

FIG. 2 is an enlarged partial cross-sectional view of a portion of the textured bearing of FIG. 1 transformed to a portion of a single curved surface rolling on a flat plate; and

FIG. 3 is a flow diagram of the method for determining the topography of the textured surface of the bearing in FIG. 1 in accordance with the present invention.

### DETAILED DESCRIPTION OF THE INVENTION

Certain terminology is used in the following description for convenience only and is not limiting. The words “inwardly” and “outwardly” refer to directions toward and away from, respectively, the geometric center of the textured rolling element bearing and designated parts thereof. The terminology includes the words above specifically mentioned, derivatives thereof and words of similar import.

Additionally, as used in the claims and in the corresponding portion of the specification, the word “a” means “at least one”. Further, unless otherwise defined the word “about” when used in conjunction with a numerical value means a range of values corresponding to the numerical value plus or minus ten percent of the numerical value. Still further, the word “or” has the meaning of a Boolean inclusive “Or”. For example, the phrase “A or B” means “A” alone or “B” alone or both “A” and “B”. Also as used in the claims and in the corresponding portion of the specification, the phrase “rolling element bearing” refers to all bearings that transfer loads via rolling elements and includes but is not limited to bearings commonly known as ball bearings and roller bearings. The term “macro-texture” refers to surface textures that are orders of magnitude greater than conventional bearing surfaces that have a roughness on the order of 10⁻⁸ meters.

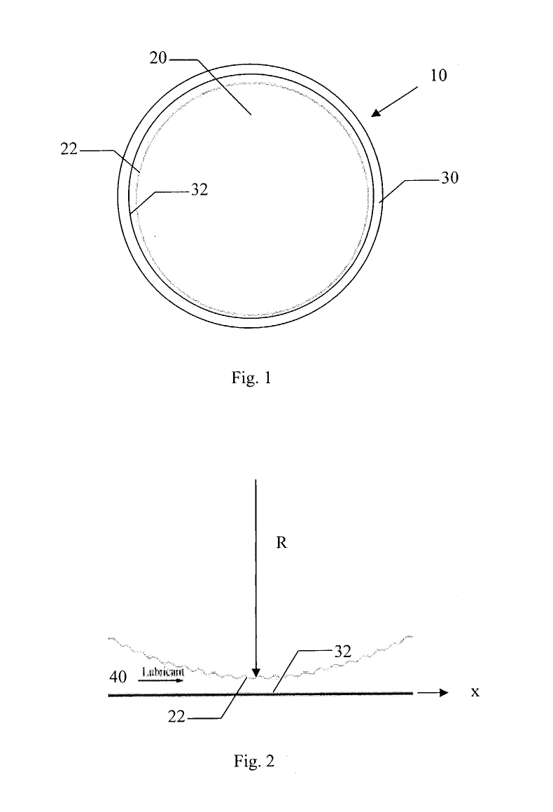

Referring to the drawings in detail, where like numerals indicate like elements throughout there is shown in FIG. 1 a first preferred embodiment of the textured rolling element bearing, generally designated 10, and hereinafter referred to as the “Bearing” 10, in accordance with the present invention. The Bearing 10 has a first bearing element 20 and a second bearing element 30. Preferably the first bearing element 20 is an elastic shaft and the second bearing element is an elastic cylinder. The first bearing element 20 has a radially outwardly facing first surface 22 with a first predetermined macro-texture 24. The second bearing element 30 has a radially inwardly facing second surface 32. The first surface 22 is rollable with respect to the second surface 32. A lubricant 40 is between the first and second surfaces 22, 32.

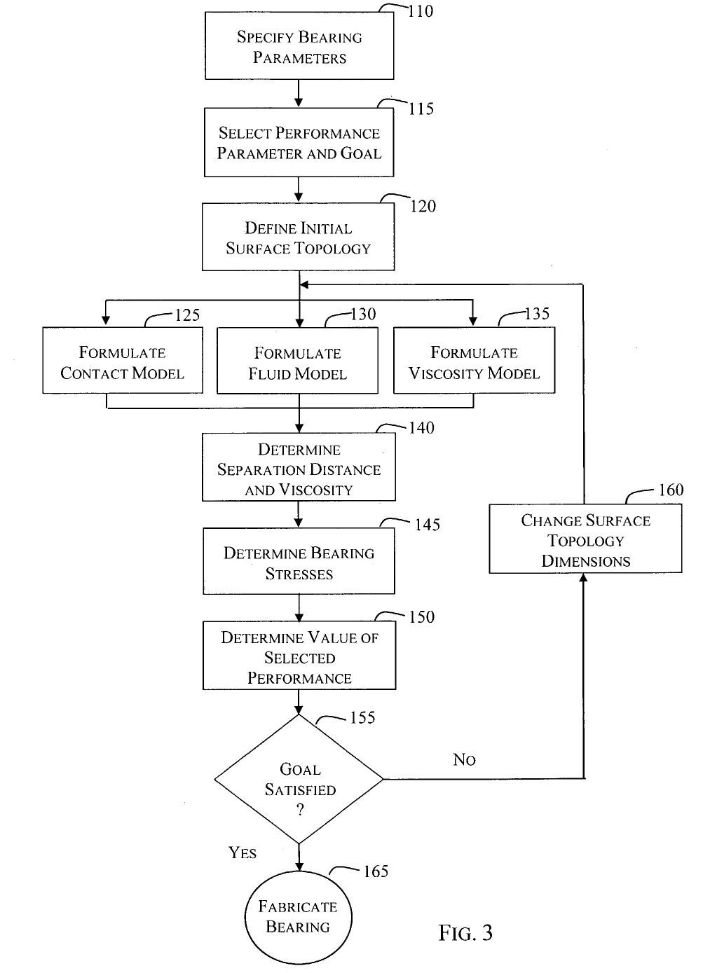

Those skilled in the art will understand from the present disclosure that the rolling contact of two curved surfaces of rolling element bearings, such as the first and second surfaces 22, 32 of the first preferred embodiment, can be equivalently represented by a single curved surface 22′ having a macro-texture 24′ rolling on a flat, smooth surface 32′, as shown in FIG. 2 and that such a representation is not limited to journal-like rolling element bearings. Accordingly, without limiting or departing from the spirit and scope of the invention, the following disclosure will be directed to FIG. 2 in which the first surface 22 corresponds to the single curved surface 22′ and the second surface 32 corresponds to the flat surface 32′.

Preferably, but not necessarily, the macro-texture 24′ of the first curved surface 22′ is a sinusoid having a first amplitude and a first wavelength. Further, the first amplitude is preferably about 0.1 to 0.5 micrometers and the first wavelength is about 10 micrometers. Although a sinusoidal texture is the preferred macro-texture and is used throughout this disclosure to teach the features of the present invention and the method discussed below for determining a particular surface topography, other surface textures such as hemispheres, hexagonal indentations, elliptical patterns and other geometries requiring more complicated models are within the scope of the present invention.

Referring to FIG. 3, there is shown a flow diagram of the steps of a preferred method for determining for the first surface 22 (or equivalent surface 22′) of the bearing 10 a topography (or macro-texture) for improving a bearing performance parameter.

In Step 110, bearing parameters such as the geometry, dimensions, and material properties of the bearing and the loads to be applied to the bearing are specified. In Step 115 a bearing performance parameter is selected and a corresponding bearing performance goal for the selected performance parameter is established. Preferably, but not necessarily, the selected performance parameter is power loss and the performance goal is a ten (10) percent or greater reduction in power loss. However, other performance parameters such as bearing life and a goal of achieving more than a ten (10) percent increase in bearing life could be selected without departing from the scope of the present invention.

In Step 120, an initial topology for the first surface 22 of the Bearing 10 is defined. Preferably, but not necessarily, the initial topology is defined to be a sinusoid as represented by the following equation:

h_{g}=A sin λx

Preferably, the amplitude “A” of the sinusoid is between about 0.1 and 0.5 micrometers and the wavelength “λ” of the sinusoid is about 10 micrometers. However, the initially assumed surface topology could be any predetermined form for a macro-structure, such as hemispherical, hexagonal, or other geometrical indentations having dimensionality that can be varied in the course of iterative computation.

There are three steps directed to formulating phenomenological models representing parameters required to characterize bearing performance. Step 125 is directed to formulating a contact model representing an elastic deformation of the first surface relative to the second surface based on a separation distance “h” between the first and second surfaces. Preferably, the contact model is given by the following equation:

$$h ( x ) = {h}_{0} + \frac{{x}^{2}}{2 R} - \frac{2}{π {E}^{*}} {\int }_{- ∞}^{∞} p ( s ) ln \vert \frac{x - s}{s} \vert ⅆ s$$

where

“x” is the axial coordinate;

“h₀” is the parallel film thickness over the contact region;

“R” is the effective radius of the first surface 22;

“E*” is the equivalent modulus of elasticity for the first bearing element 20; and

“p(s)” is the pressure of the lubricant 40.

Those skilled in the art will recognize the preferred contact model as a Hertzian contact model and will also understand that the parallel film thickness can be computed from standard expressions, such as the expressions set forth in A. CAMERON, THE PRINCIPLES OF LUBRICATION, (1966) John Wiley & Sons, Inc., New York (“CAMERON”), pages 203-208.

Step 130 is directed to formulating a fluid model representing a pressure “p” of the lubricant 40 between the first surface 22 and the second surface 32. Preferably, the fluid model is based on the following equation:

$$\frac{ⅆ p}{ⅆ x} = 6 μ ( {v}_{1} + {v}_{2} ) ( \frac{h - {h}^{*}}{{h}^{3}} )$$

where

“p” is the fluid pressure of the lubricant 40;

“v₁” and “v₂” are the transverse velocities of the first and second surfaces 22, 32;

“h” is the fluid film thickness of the lubricant 40;

“h*” is the film thickness at which dp/dx=0; and

“μ” is the coefficient of viscosity of the lubricant 40.

Those skilled in the art will recognize the preferred fluid model as Reynolds equation.

Step 135 is directed to formulating a viscosity model representing a viscosity “μ” of the lubricant 40 based on the pressure “p” of the lubricant 40. Preferably, the viscosity model is based on the following equation:

μ=μ₀e^{λp}

where

“μ₀” is a nominal viscosity; and

“λ” is the exponent.

Those skilled in the art will recognize the preferred viscosity model as Barus's equation and will also understand that the values for “μ₀” and “λ” can be obtained from standard handbooks for specific lubricants, such as TEDRIC A. HARRIS, ROLLING BEARING ANALYSIS, 4^{th} Ed., (2001) John Wiley & Sons, Inc., New York (“HARRIS”), pages 424-427, or empirical data.

Step 140 is directed to determining simultaneously the separation distance “h”, the pressure “p”, and the viscosity “μ” by analytical approximation and numerical simulation of the contact model, the fluid model, and the viscosity model. Preferably, the analytical approximation presumes that when surfaces are rough, the lubricant film thickness that separates the mean planes of the rough surfaces can be calculated as if the surfaces were smooth. Those skilled in the art will recognize this approximation as a derivative of the Greenwood and Williamson model for the contact of real active rough surfaces. See HARRIS, pages 465-473. As applied to the first and second equivalent surfaces 22′ and 32′ shown in FIG. 2, the approximation assumes that the lubricant film thickness that separates the mean plane of the macro-texture of the first equivalent surface 22′ from the second equivalent surface 32′ can be calculated as if both surfaces were smooth. Other approximations for modeling surface roughness that could be used without departing from the scope and spirit of the invention include finite differences.

The preferred numerical simulation for determining simultaneously the separation distance “h”, the pressure “p”, and the viscosity “μ” is finite differences. Other simulations that could be used without departing from the scope and spirit of the invention include the finite element method, asymptotic approximations, and the method of averaging.

Step 145 is directed to determining bearing stresses. The stress equations used in Step 145 are standard expressions well known to those skilled in the art, are typified by the teaching in HARRIS, pages 183-230, and for brevity will not be reproduced here. However, by way of example, if the selected performance parameter is power loss, the Newtonian shear stress “τ” is determined, preferably in accordance with the following equations:

$$τ = - μ \frac{\partial u}{\partial x}$$

$$u = \frac{1}{2 μ} \frac{\partial p}{\partial x} x ( z - h ) + ( {v}_{1} + {v}_{2} ) ( 1 - \frac{z}{h} )$$

where

“u” is the lubricant velocity in the “x” direction (FIG. 2);

“μ” the viscosity determined in Step 140;

“h” is the separation distance determined in Step 140;

“p” is the pressure determined in Step 140; and

“v₁” and “v₂” are the transverse velocities of the first and second surfaces 22, 32.

Step 150 is directed to determining a value for the bearing performance parameter based on the separation distance, viscosity and pressure determined in Step 140 and the bearing stresses determined in Step 145. For example, if the selected performance parameter is power loss, bearing frictional torque “T” is first determined, preferably by the following integration carried out over the contact area of the bearing:

T=R_{b}∫τdA

where

“R_{b}” is a nominal radius of the bearing; and

“τ” is the Newtonian shear stress determined in Step 145.

Power loss is then determined as a function of the friction torque “T” in accordance with the following equation:

P=Tω

where “ω” is the angular velocity of the bearing.

Step 155 is directed to ascertaining whether the bearing performance goal has been satisfied by comparing the computed value of the performance parameter to the value of the selected goal.

Step 160 is directed to incrementally changing the topology and repeating Steps 125 to 150 until the bearing performance goal has been satisfied. Preferably, for the sinusoidal macro-texture disclosed above, the values for the amplitude “A” and wavelength “λ” are incremented by about 0.1 percent for each iteration. However, various methods for incrementing two variables in an iterative computation are well known in the art and could be used without departing from the scope and spirit of the method disclosed herein.

Step 165 provides for fabricating a bearing with the first surface 22 having the topology satisfying the bearing performance goal, such as bearing life or power loss. As the methods for fabricating bearings are well known and not part of the invention claimed herein, for brevity such methods will not be disclosed herein.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A textured rolling element bearing comprising
a first bearing element having a first surface with a first predetermined macro-texture,
a second bearing element having a second surface; and
a lubricant between the first and second surfaces,
wherein the first surface is rollable with respect to the second surface.

2. The bearing according to claim 1, wherein the first predetermined macro-texture is a sinusoid having a first amplitude and a first wavelength.

3. The bearing according to claim 2, wherein the first amplitude is about 0.1 to 0.5 micrometers and the first wavelength is about 10 micrometers.

4. A method for determining for a first surface of a rolling element bearing a topography for improving a bearing performance parameter, the first surface rollable relative to a second surface of the bearing, a lubricant between the first surface and the second surface, the method comprising the steps of:
(a) selecting a bearing performance parameter and establishing a corresponding bearing performance goal;
(b) prospectively defining a topography for the first surface of the bearing;
(c) formulating a contact model representing an elastic deformation of the first surface relative to the second surface based on a separation distance “h” between the first and second surfaces;
(d) formulating a fluid model representing a pressure “p” of the lubricant between the first surface and the second surface;
(e) formulating a viscosity model representing a viscosity “μ” of the lubricant based on the pressure of the lubricant;
(f) determining simultaneously the separation distance, the pressure, and the viscosity by analytical approximation and numerical simulation of the contact model, the fluid model, and the viscosity model;
(g) determining bearing stress based on the separation distance, the pressure, and the viscosity determined in step (f);
(h) determining a value for the bearing performance parameter based on the separation distance, the pressure, and the viscosity determined in step (f) and the bearing stress determined in step (g);
(i) ascertaining whether the bearing performance goal has been satisfied; and
(j) if the bearing performance goal has not been satisfied, then incrementally changing the topology and repeating steps (f), (g), and (h) until the bearing performance goal has been satisfied.

5. The method of claim 4 further comprising the step of fabricating a bearing with the first surface having the topology satisfying the bearing performance goal.

6. The method of claim 4 wherein the bearing performance parameter is power loss or bearing life, the contact model is a Hertzian contact model, the fluid model is based on Reynolds equation, and the viscosity model is based on Barus's equation.

7. The method of claim 6, wherein the prospectively defined topology is a sinusoid with an initial wave length and an initial amplitude,

8. The method of claim 7, wherein the initial wavelength is about 10 micrometers and the initial amplitude is about 0.1 to 0.5 micrometers.

9. The method of claim 4, wherein the performance parameter is power loss.

10. The method of claim 4, wherein the performance parameter is bearing life.
